(19) United States
(12) Patent Application Publication
(10) Pub. No.: US 2009/0258201 A1
(43) Pub. Date: Oct. 15, 2009

(54) Glass Article Having Pattern Embedded Therein And Preparation Method Thereof

(76) Inventors: Shin Hye SONG, Yongin-si (KR); HYUN DUK JEON, Yongin-si (KR); HYUN JI JEON, Yongin-si (KR)

Correspondence Address: SUGHRUE MION, PLLC, 2100 PENNSYLVANIA AVENUE, N.W., SUITE 800, WASHINGTON, DC, 20037, US

(21) Appl. No.: 12/359,781

(22) Filed: Jan. 26, 2009

(30) Foreign Application Priority Data
Apr. 15, 2008 (KR) 10-2008-0034729

(51) Int. Cl. B32B 3/10; B32B 17/00; B32B 37/06

(52) U.S. Cl. 428/203; 156/99

(57) ABSTRACT

Disclosed is a method of preparing a glass article, which comprises disposing a first glass layer on a fire-resistant substrate, applying at least one patterning material selected from the group consisting of a clay and a quartz powder on a preformed patterning region of the first glass layer to form a pattern, disposing a second glass layer on the surface of the first glass layer having the pattern to form a glass laminate, followed by drying, firing and cooling the glass laminate.

### FIELD OF THE INVENTION

The present invention relates to a glass article having a pattern embedded therein and a preparation method thereof.

### BACKGROUND OF THE INVENTION

Glass has been widely used in various applications, particularly in the manufacture of various glass articles due to its hardness, high gloss, and transparency.

Methods of producing colored and patterned glass articles include forming a predetermined pattern on one surface of a glass plate using a coloring paint, or depositing thereon a powder of loess, kaolin, sand, coal or rock using an adhesive. Also, a method of attaching a coating film having a predetermined color to a glass plate using an adhesive to form a predetermined pattern may be employed. However, these methods are disadvantageous because the pattern formed on the surface of the glass plate may be damaged over a long period of use due to the actions of moisture, pollutants, friction, and weathering.

To solve such problems, there has been proposed a method of manufacturing a decorative glass panel by applying a transparent glass powder or a colored glass powder with or without the use of a pigment to a predetermined thickness to one surface of a glass plate, disposing a second glass plate on the treated glass plate, and firing the glass plate laminate. This method produces a pattern formed between the glass plates, thus solving the above mentioned problems. However, this method is also problematic in that the glass powder used is required to have the same properties as those of the upper and lower glass plates. Specifically, when a glass powder having properties different from those of the glass plates used, defects in the form of foam or crack may develop due to, e.g., different coefficients of thermal expansion of the glass components. Also, there arises the problem that the glass powder used for patterning smears during the high temperature treating step, to cause smudging of the pattern.

Thus, many materials having thermal expansion coefficients different from those of the glass used would generate defects in the form of foam or crack during firing and cooling, and therefore, they cannot be used to form a stable and durable pattern in a glass articles.

### SUMMARY OF THE INVENTION

Accordingly, it is an object of the present invention to provide a glass article within which a clear color or a pattern is embedded.

It is another object of the present invention to provide a method of preparing a glass article having an ingrained pattern formed without generating defects in the form of foam or crack even when using relatively large-sized glass plates.

In accordance with one aspect of the present invention, there is provided a glass article having a pattern embedded therein using at least one patterning material selected from the group consisting of a clay and a quartz powder.

In accordance with another aspect of the present invention, there is provided a method of preparing a glass article having a pattern embedded therein, comprising: disposing a first glass layer on a fire-resistant substrate, forming a pattern on the surface of the first glass layer using at least one patterning material selected from the group consisting of a clay and a quartz powder, disposing a second glass layer on the patterned surface of the first glass layer, to form a glass laminate, drying the glass laminate at 30° C. to 50° C., firing the dried glass laminate at 700° C. to 800° C., and maintaining the fired glass laminate at 500° C. to 600° C. for 1 to 10 hours to anneal the fired laminate, followed by slowly cooling the annealed glass laminate to room temperature.

### DETAILED DESCRIPTION OF THE INVENTION

In order to prepare a glass article according to the present invention, a fire-resistant substrate, a first glass layer, a second glass layer and a patterning material are used.

Examples of the fire-resistant substrate include gypsum, biscuit fired pottery, ceramic, and metal molds. The substrate may be flat, uneven, or recessed. The use of a flat substrate is preferable. In the case of an uneven or recessed substrate, it may have a depth fluctuation in the order of about 5 cm or less. In case when a kiln is used, the interior of the kiln may be utilized in place of the substrate, but the use of a substrate is desirable in terms of washing and repetitive use.

The substrate has a size larger than that of the first glass layer.

Also, in order to easily remove the glass article from the substrate after the completion of the preparative procedures, a release agent may be applied in advance on the substrate. Examples of such a release agent include, but are not limited to, a 50:50 mixture of gypsum and quartz powder, and SHELF PRIMER™ which is mainly composed of alumina (available from Ropak, Canada). A ceramic paper may also be used in lieu of the release agent.

The first glass layer is then disposed on the substrate.

The first glass layer may be formed using a silicate glass such as sodium lime glass (i.e. soda lime glass), potassium lime glass, lead glass, barium glass, and silica glass, preferred among which is sodium lime glass. The first glass layer may be transparent or colored.

Although there is no need to limit the size of the first glass layer, the first glass layer may have a size ranging from 1 cm×1 cm to 2 m×2 m for the easiness of handling the glass article. The first glass layer may have various shapes such as a square, a rectangle, a lozenge, a circle, an ellipse, a semi-circle, a star, and an irregular pattern.

Subsequently, to form the pattern on the first glass layer, a patterning material comprising at least one selected from clay and quartz powders is prepared, and the patterning material may further comprise an adjuvant selected from a pigment, water, and an adhesive.

Examples of the clay are kaolin such as kaolinite, dickite, halloysite and others, montmorillonite such as montmorillonite, bentonite, acidic white clay and others, mica such as illite, glauconite and others, chlorite, and allophan. The above mentioned clay materials may be used alone or in combinations thereof, preferred among which are white porcelain clay, super white clay, combined clay, china white clay, and celadon porcelain clay for use in porcelain production. Further, the clay in the form of biscuit or glaze fired may not be used to enhance its adhesion to the glass plate. Examples of the quartz include natural quartz such as coastal sand and pit sand as well as an artificial quartz, which may be used alone or in combination. Particularly useful is a white quartz powder when the color of the pigment is required to manifest itself. Examples of the pigment include inorganic and organic pigments, preferred among which is a low- or high-fired pigment. The adhesive used may be of any kind that adheres to glass.

Subsequently, the patterning components mentioned above are blended and applied on a predetermined part of the first glass layer to form a pattern, which may be of a regular or irregular shape. For example, the pattern may be of a specific shape, such as a human body, a natural object (e.g. animal, plant, sun, river, ocean, etc.), a building and a manufactured good or it may show an abstract figure.

According to an embodiment of the present invention, the pattern may be formed using a clay powder having a desired shape which is attached to the upper surface of the first glass layer using an adhesive for glass to form a pattern. In this case, the use of water is not necessarily required, but even if water is added, the amount of water used is set at a level that enables the clay to form a desired shape. Also, depending on the water content of the clay, the clay may be mixed with a pigment at a volume ratio of 1:1 to 2:1 to manifest the desired color tone.

In case when the clay contains a sufficient predetermined level or more of water, the clay itself or a clay/pigment mixture is viscous enough to form a pattern on the first glass layer without the use of an adhesive. However, in order to form a stable pattern, the pattern is shaped by forming a desired pattern design on the first glass layer using an adhesive and then disposing a clay powder, a clay/water mixture, a clay/pigment mixture, or a clay/pigment/water mixture thereon.

In some occasions, a draft of a pattern is drawn on the first glass layer using a dyestuff, a paint, or a pen, and a pattern is formed on the drafted area using any combination of a clay, a pigment, and water.

According to another embodiment of the present invention, the pattern may be formed using a quartz powder as a main material. In this case, a predetermined pattern is formed on the first glass layer using an adhesive, and then attaching the quartz powder on the pattern coated with the adhesive. Alternatively, the pattern may be formed by mixing a quartz powder with a pigment at a volume ratio of 2:1 to 3:1, or mixing a quartz powder/pigment mixture with water at a volume ratio of 1:1 to 2:1. Unlike the clay, a quartz powder is not viscous, and thus, the use of an adhesive is preferable for stable pattern formation. Further, on some occasions, a draft is drawn on the first glass layer using a dyestuff, a paint or an ink, an adhesive is applied on the draft, and then a quartz powder, a quartz powder/pigment mixture or a quartz powder/pigment/water mixture is deposited thereon.

According to a further embodiment of the present invention, the pattern may be formed using both a clay and a quartz powder. In this case, the clay and the quartz powder may be mixed at a volume ratio of 1:1 to 2:1, a clay/quartz powder mixture may be mixed with a pigment at a volume ratio of 1:1 to 2:1, or a clay/quartz powder/pigment mixture may be mixed with water at a volume ratio of 1:1 to 2:1. In this way, an entire pattern may be formed using a quartz powder and a clay. Alternatively, a part of a pattern may be formed using a clay/pigment/water mixture, while the other part of the pattern may be formed using a quartz powder/pigment/water mixture. Further, in addition to the pattern formed using the above mentioned mixtures, an additional pattern may be formed using a tool.

According to still another embodiment of the present invention, a clay, a quartz powder or a mixture thereof may be attached to the upper surface of a first glass layer to form a primary pattern, after which a pigment is applied on the primary pattern to complete a final pattern. One or more of the pigments having different colors may be used.

The thickness of the pattern formed on the first glass layer may be 3 mm or less, preferably 2 mm or less. If the thickness of the pattern exceeds 3 mm, the adhesion between the first glass layer and the second glass layer becomes poor during the process of preparing the glass article, leading to the generation of defects therebetween.

Subsequently, the second glass layer is disposed on the first glass layer having the pattern formed thereon, to form a glass laminate.

The second glass layer may be formed of a silicate glass such as sodium lime glass (soda lime glass), potassium lime glass, lead glass, barium glass, and silica glass. Particularly useful is sodium lime glass. In this case, the second glass layer may be of the same kind as the first glass layer.

The size of the second glass layer may be the same as, or different from, that of the first glass layer, and the size of the second glass layer is not limited as long as the entire pattern is covered with the second glass layer composed of a single piece or plural pieces.

The second glass layer may have various shapes such as a square, a rectangle, a lozenge, a circle, an ellipse, a semi-circle, and a star, or may have an irregular shape.

Preferably, the first glass layer and the second glass layer each has a size not larger than 30 cm×30 cm. At least one of the fire-resistant substrate, the first glass layer, and the second glass layer preferably has at least one exhaust port. In case when the fire-resistant substrate has an exhaust port, the first glass layer or the second glass layer may not have an exhaust port. In contrast, in case when the fire-resistant substrate does not have an exhaust port, the first glass layer or the second glass layer is required to have an exhaust port. Also, in case when the first glass layer has an exhaust port, the second glass layer may not have an exhaust port. In contrast, in case when the first glass layer does not have an exhaust port, the second glass layer preferably has an exhaust port. On some occasions, both the first glass layer and the second glass layer may each have an exhaust port. When the first glass layer and the second glass layer each has a size not larger than 30 cm×30 cm or has a pattern which is densely and complicatedly formed, it is preferred that each of the glass layers is equipped with an exhaust port.

In case when each of the first glass layer and the second glass layer has an exhaust port, the exhaust port may be located at the same or different positions. In particular, when the exhaust ports are located at different positions, the elimination of foam is facilitated.

The exhaust port serves as a conduit for eliminating the foam generated during firing and cooling of the glass laminate.

Also, when only the first glass layer or the second glass layer has an exhaust port, the diameter thereof is preferably in the range of 1 mm to 3 mm. If said diameter of the exhaust port is less than 1 mm, it is difficult to effectively eliminate the foam generated during preparation of the glass article, while if the diameter of the exhaust port exceeds 3 mm, the exhaust port remains unfilled after the preparation of the glass article.

In case the fire-resistant substrate has an exhaust port, it preferably has a diameter of 1 mm to 3 mm. If the diameter of the exhaust port is less than 1 mm, it is difficult to effectively eliminate the foam from the glass laminate during the preparation of the glass article, while if the diameter of the exhaust port exceeds 3 mm, the surface of the finished glass article becomes flawed by the mark of the substrate's port.

The exhaust port is preferably located at the center of the substrate, the first glass layer, or the second glass layer rather than at the outer portion thereof, particularly at a position where the pattern density is high.

The exhaust part provided to the substrate, the first glass layer, or the second glass layer may be formed using a drill bit having a predetermined width. On some occasions, it is advantageous to use a drill bit coated with diamond or other abrasive material at the end thereof. Alternatively, the exhaust port may be formed by an ultrasonic process at a frequency of about 16 kHz to 30 kHz, or by a hot punching process which involves partial softening of the glass by heating and perforating the softened glass using a punch, but the present invention is not limited thereto.

Also, the first glass layer or the second glass layer may have a plurality of exhaust port depending on the size of the glass plate. The number of exhaust ports may vary depending on the shape of the pattern to be embedded in the glass layer. Specifically, when the glass layer is relatively large and the pattern is complicatedly and densely formed, the use of multiple exhaust ports becomes effective. In such case, the multiple exhaust ports may be disposed at an interval of 30 cm or less. If the interval of the exhaust ports exceeds 30 cm, the foam may not be completely eliminated.

The thickness of the first glass layer is preferably in the range of 3 mm to 10 mm. If less than 3 mm, the glass layer tends to break during the exhaust port forming step, while if it is thicker than 10 mm, the foam may not be effectively eliminated.

Also, at least one of the first glass layer and the second glass layer may be of a mosaic form composed of two or more glass pieces. In case when the first glass layer is of a mosaic form, the second glass layer may not be of a mosaic form. In contrast, in case when the first glass layer is not of a mosaic form, the second glass layer may be of a mosaic form. On some occasions, both the first glass layer and the second glass layer may be of a mosaic form. When the first glass layer and the second glass layer have a size not larger than 30 cm×30 cm, or have a pattern which is dense and complicated, they are preferred to be of a mosaic form composed of multiple glass pieces.

Also, the first glass layer and the second glass layer may be colored. In case when the first glass layer is of a mosaic form with various colors, the second glass layer may be transparent to manifest the pattern and the color of the first glass layer.

In case when at least one of the first glass layer and the second glass layer is of a mosaic form composed of glass pieces, there is no need to limit the number and shape of the glass pieces. Also, although there is no need to limit the gap between the glass pieces, the gap of the glass pieces is preferably 2 mm or less. If the gap of the glass pieces exceeds 2 mm, the glass pieces may not be bonded to each other after completion of the glass article.

In case when the first glass layer or the second glass layer is of a mosaic form composed of glass pieces, respective glass pieces may be of different kinds of glass. When the glass pieces are disposed in a mosaic form at a predetermined pattern, foam generated during the preparation of the glass article may be sufficiently eliminated. Also, in case when glass pieces having different coefficients of thermal expansion are heated and cooled together, stress generated due to the different thermal expansion coefficients of the glass components may be relieved through relaxation thereof at the gap region, thus preventing the glass article from cracking.

Alternatively, a process of applying a predetermined pressure to the glass laminate may be performed to embed the pattern therein. In this case, the magnitude of pressure is set at a level that enables to fix the pattern.

Subsequently, the glass laminate having the pattern is dried at 30° C. to 50° C. for 1 hour to 1 day. In case when the drying temperature is higher than 50° C., the pattern may crack, while when the drying temperature is lower than 30° C., the drying time becomes too long.

When the manufactured glass laminate has a high water content, the glass laminate should be dried sufficiently before use.

Subsequently, the dried glass laminate is fired to fuse them together and cooled. The fusing process is performed by heating the glass components to the fusing temperature of the glass laminate using an oven or a kiln.

The firing of the glass laminate may be performed at a temperature of 700° C. to 800° C. for 30 min to 2 hours depending on the kind of glass. When a soda lime glass laminate is used, the firing may be performed at 720° C. to 730° C. for 30 min to 50 min, while when a soda glass laminate is used, the firing may be performed at 750° C. to 780° C. for 1 to 1.5 hours.

When a laminate of two glass plates is fired, it fuses while softening occurs at the surface or edge thereof. In case, when the size of the glass plate exceeds 30 cm, foams generated at the laminate interface can be effectively eliminated through one or more of the exhaust ports provided thereto.

The cooling of the fired glass laminate may be performed first at 500° C. to 600° C. for 1 to 10 hours and preferably 5 to 10 hours, to anneal the fired glass laminate, and then slowly cooled the annealed glass laminate to room temperature over 10 to 24 hours, preferably 12 to 20 hours. The cooling conditions may vary depending on the kind and thickness of the glass laminate. Particularly, when a soda glass of 3 mm thick is used, the fired glass laminate may be maintained at 530° C. for 6 to 7 hours and then slowly cooled to room temperature over 12 to 15 hours. When a general window glass of 6 mm thick is used, the fired glass laminate may be maintained at 550° C. for 6 to 7 hours and then slowly cooled to room temperature over 12 to 15 hours. As the size or the thickness of the glass ware increases, it is preferred that the cooling time be prolonged.

After the completion of the cooling process, the substrate is removed to obtain a completed glass article.

In case when the quartz powder, the quartz powder/pigment mixture or the quartz powder/pigment/water mixture without the clay is used as a patterning material, the glass laminate obtained after slowly cooling the annealed glass laminate obtained in the last step, may be second fired using a slumping process, or may be shaped using a blowing process. However, in case when the clay is used as the patterning material, the clay may become cracked by the additional slumping process or blowing process. Accordingly, in case when the clay itself or the clay/quartz powder mixture is used as a patterning material, it is preferred that the additional slumping process or blowing process is not performed.

The slumping process is performed by disposing the glass laminate obtained after slowly cooling the annealed glass laminate obtained in the last step, on a fire-resistant mold having a predetermined shape and then applying heat thereto to thus shape glass using physical properties of glass in which glass subsides by weight and gravity of glass itself while being softened in the presence of heat.

However, when the form of glass is remarkably changed in a state in which the pattern between the first glass layer and the second glass layer is not completely fused, the pattern is not stably attached to glass but is deformed or additional foam may occur. Thus, in case when the degree of change is large, particularly, in case when a slumping process is performed using a curved or uneven mold having a depth exceeding 5 cm, it is preferred that the fusing process of the glass laminate is performed, followed by performing the slumping process. In contrast, in case when a curved or uneven mold having a depth of 5 cm or less is used, a fusing process and a slumping process may be simultaneously performed using the above mentioned fire-resistant mold, to obtain a glass article.

In order to additionally shape the glass article using a slumping process, the primary glass product obtained by a fusing process is disposed on a fire-resistant mold having a predetermined shape. Examples of the mold include, but are not limited to, a gypsum mold, a biscuit fired porcelain mold, a ceramic mold and a metal mold, and the mold may have various shapes such as a curved shape and an uneven shape. In case when the mold has a curved or uneven shape, the mold may have a depth exceeding 5 mm depending on the shape to be represented. Depending on the shape of the mold, the glass article according to the present invention may have various shapes.

Further, in order to easily remove glass from the mold after the completion of the preparation process, a release agent may be applied in advance on the mold. Examples of such a release agent include, but are not limited to, a 50:50 mixture of gypsum and quartz powder, and SHELF PRIMER™ which is mainly composed of alumina (available from Ropak, Canada). A ceramic paper may also be used in lieu of the release agent.

Subsequently, the primary glass product disposed on the mold is subjected to secondary firing and secondary cooling under conditions similar to those of primary firing and primary cooling, depending on the kind of glass. Particularly, the secondary firing is performed by maintaining the glass laminate at a fusing temperature of 700° C. to 800° C. for 30 min to 2 hours depending on the kind of glass. The secondary cooling is performed by maintaining the glass laminate at a temperature of 500° C. to 600° C. for 1 to 10 hours, preferably 5 to 10 hours and then slowly cooling it to room temperature over 10 to 24 hours, preferably 12 to 20 hours.

In addition, the blowing process for additionally shaping the glass article is performed by melting a quartz powder and soda in a furnace at 1500° C. to obtain a molten glass, gathering a wad of the molten glass on the end of an iron blowpipe, and forming the molten glass to have a predetermined shape by blowing air through the iron blowpipe

In case when the blowing process is further performed, the glass product having the pattern formed by the fusing process may be used in the blowing process as it is, or may be used after cutting to a predetermined size and preheating to 600° C. to 800° C.

Subsequently, a batch or cullet composed of a silica, a limestone or a soda which is a material for glass is melted in a kiln at 1250° C. to 1500° C., and then applied to a preheated blowpipe. The glass is generally transparent. But, in case when various colors are intended to be shown, a glass rod having a desired color may be applied to the blowpipe covered with the transparent glass, followed by performing air blowing. Example of the glass rod includes a glass rod (available from Kugler, Germany). Any glass rod may be used as long as the component thereof is the same as that of the blowing glass.

Subsequently, the blowpipe is further covered with a transparent molten glass while air is introduced thereto, after which the preheated glass product obtained through a fusing process is attached thereto. Subsequently, thermal treatment is performed several times so that the primary glass product is closely adhered to the surface of the blowing glass ware, and then air blowing is carried out to obtain a product having a desired shape. In this case, air is introduced only to the extent that the pattern of the primary glass product is not greatly changed. Subsequently, the glass product may be thermally treated several times in a glory hole and then shaped to have a desired shape using tweezers.

The glass product thus formed is maintained at 500° C. to 600° C. for 5 to 10 hours and then slowly cooled to room temperature over 12 to 20 hours, to obtain a secondary glass product. In this case, as the size or the thickness of the glass product increases, it is preferable that the cooling time is prolonged.

As described above, in accordance with the present invention, various glass articles such as small-sized glass accessories, cookwares, glass craftwork and decorative windows, having a pattern embedded therein can be effectively prepared using the inventive method.

The following examples are given for the purpose of illustration only, and are not intended to limit the scope of the invention.

### EXAMPLE 1

### Preparation of a Glass Article by a Fusion Process Using Clay

A glass article was prepared by a fusion process using two sheets of glass available from Hanglass, Korea. As a lower glass sheet, a 6 mm thick blue glass plate having the size of 45 cm×45 cm was used, and as an upper glass layer, a 5 mm thick transparent glass plate having the size of 45 cm×45 cm was used. A pre-designed pattern was formed on the surface of the lower glass layer using an adhesive, and then, the pattern was treated with a powder of china white clay, super white clay, celadon porcelain clay or colored clay (without the use of a pigment) to manifest the pattern. In the above patterning step, a mixture of clay and water at a volume ratio of 5:1 was used. Subsequently, the upper glass layer was laminated thereon to form a glass laminate. The glass laminate having the pattern embedded therebetween was de-watered at 40° C. for 5 hours. The dry glass laminate was disposed on a biscuit fired and dish-shaped porcelain mold having a single exhaust port having a diameter of 2 mm, fired in a kiln at 780° C. for 1 hour, maintained at 550° C. for 7 hours, and then slowly cooled to room temperature over 15 hours, to obtain a glass article.

### EXAMPLE 2

### Preparation of a Glass Article by a Fusion Process Using Quartz Powder

A glass article was prepared by a fusion process using two sheets of spectrum 96 soda glass, USA. As a lower glass sheet, a 3 mm thick spectrum 96 soda glass having the size of 30 cm×30 cm was used, and as an upper glass layer, a 6 mm thick spectrum 96 soda glass having a size of 30 cm×30 cm was used. A pre-designed pattern was formed on the surface of the lower glass layer using an adhesive, and then a pattern was treated with a mixture of white quartz powder and water at a volume ratio of 2:1 to manifest the pattern. Subsequently, the upper glass layer was laminated thereon to form a glass laminate. The glass laminate having the pattern embedded therebetween was de-watered at 40° C. for 1 hour. Subsequently, the dry glass laminate was disposed on a biscuit fired and dish-shaped porcelain mold, fired in a kiln at 725° C. for 30 min, maintained at 530° C. for 6 hours, and then slowly cooled to room temperature over 13 hours, to obtain a glass article.

### EXAMPLE 3

### Preparation of a Glass Article by a Fusion Process Using Quartz Powder and Pigment

A glass article was prepared by a fusion process using two sheets of spectrum 96 soda glass, USA. As a lower glass sheet, a 3 mm thick green spectrum 96 soda glass having a size of 30 cm×30 cm was used, and as an upper glass layer, a 6 mm thick transparent spectrum 96 soda glass having a size of 30 cm×30 cm and three exhaust ports having a diameter of 2 mm was used. A pre-designed pattern was formed on the surface of the lower glass layer using an adhesive, and then a pattern was treated with a mixture of quartz powder, pigment and water at a volume ratio of 5:3:2 to manifest the pattern. In the above patterning step, as the quartz powder, natural quartz was used, and as the pigment, a low-fired pigment was used. Subsequently, the upper glass layer was laminated thereon to form a glass laminate. The glass laminate having the pattern embedded therebetween was de-watered at 40° C. for 2 hours. Subsequently, the dry glass laminate was disposed on a biscuit fired and dish-shaped porcelain mold, fired in a kiln at 720° C. for 20 min, maintained at 520° C. for 6 hours and then slowly cooled to room temperature over 12 hours, to obtain a glass article.

### EXAMPLE 4

### Preparation of a Glass Article by a Fusion Process Using Quartz Powder and Pigment

A glass article was prepared by a fusion process using two sheets of spectrum 96 soda glass. As a lower glass sheet, a 3 mm thick four colored spectrum 96 soda glass pieces designed to have various sizes were used, and as an upper glass layer, a 6 mm thick transparent spectrum 96 soda glass having a size of 60 cm×60 cm was used. A pre-designed pattern was formed on the surface of the lower glass layer using an adhesive, and then the pattern was treated with a mixture of quartz powder, pigment and water at a volume ratio of 5:3:2. In the above patterning step, as the pigment, a low-fired pigment was used. Subsequently, the upper glass layer was laminated thereon to form a glass laminate. The glass laminate having the pattern embedded therebetween was de-watered at 40° C. for 2 hours. Subsequently, the dry glass laminate was disposed on a biscuit fired and dish-shaped porcelain mold, fired in a kiln at 725° C. for 30 min, maintained at 520° C. for 7 hours and then slowly cooled to room temperature over 15 hours, to obtain a glass article.

### EXAMPLE 5

### Preparation of a Glass Article by a Fusion Process Using Quartz Powder and Pigment

A glass article was prepared by a fusion process using window glass available from Hanglass, Korea. As a lower glass sheet, a 5 mm thick green window glass plate having a size of 120 cm×30 cm was used, and as an upper glass layer, a 5 mm thick transparent window glass plate having a size of 120 cm×30 cm was used. White quartz powder was uniformly sprinkled on the entire surface of the lower glass layer using an adhesive, and then a pigment was naturally sprinkled thereon using a sieve depending the pre-designed pattern. Subsequently, a pattern was formed using the finger and a tool, and the upper glass layer was laminated thereon to form a glass laminate. The glass laminate having the pattern embedded therebetween was de-watered at 40° C. for 5 hours. Subsequently, the dry glass laminate was disposed on a biscuit fired and dish-shaped porcelain mold, fired in a kiln at 760° C. for 1 hour, maintained at 550° C. for 7 hours and then slowly cooled to room temperature over 15 hours, to obtain a glass article.

### Example 6

### Preparation of a Glass Article a Fusion Process Using Quartz Powder, Clay, and Pigment

A glass article was prepared by a fusion process using two sheets of soda glass available from Hanglass, Korea. As a lower glass sheet, a 3 mm thick blue glass plate having a size of 30 cm×30 cm was used, and as an upper glass layer, a 6 mm thick transparent glass plate having a size of 30 cm×30 cm was used. A pre-designed pattern was formed on the surface of the lower glass layer using an adhesive, and then the pattern was treated with a mixture of quartz powder, clay, pigment and water at a volume ratio of 3:4:2:1. In the above patterning step, as the quartz powder, white quartz powder was used, and as the clay, china white clay and white porcelain clay were used. Also, as the pigment, a low-fired pigment was used. Subsequently, the upper glass layer was laminated thereon to form a glass laminate. The glass laminate having the pattern embedded therebetween was de-watered at 40° C. for 5 hours. Subsequently, the dry glass laminate was disposed on a biscuit fired and dish-shaped porcelain mold, fired in a kiln at 760° C. for 1 hour, maintained at 550° C. for 6 hours and then slowly cooled to room temperature over 12 hours, to obtain a glass article.

### EXAMPLE 7

### Preparation of a Glass Article by a Fusion Process and a Slumping Process Using Quartz Powder and Pigment

A glass article was prepared through a fusion process and slumping process using two sheets of spectrum 96 soda glass. As a lower glass layer, a 3 mm thick orange opaque spectrum 96 soda glass having a size of 30 cm×30 cm was used, and as an upper glass layer, a 6 mm thick transparent spectrum 96 soda glass having a size of 30 cm×30 cm and a single exhaust port having a diameter of 2 mm was used. A pre-designed pattern was formed on the surface of the lower glass layer using an adhesive, and then the pattern was treated with a mixture of quartz powder, pigment and water at a volume ratio of 5:3:2. In the above patterning step, as the quartz powder, white quartz powder was used, and as the pigment, a low-fired pigment was used. Subsequently, the upper glass layer was laminated thereon to form a glass laminate. The glass laminate having the pattern embedded therebetween was de-watered at 40° C. for 2 hours. Subsequently, the dry glass laminate was disposed on a biscuit fired and dish-shaped porcelain mold, fired in a kiln at 720° C. for 40 min, maintained at 530° C. for 6 hours and then slowly cooled to room temperature over 15 hours, thus obtaining a primary glass product. Then, the primary glass product was disposed on a mold having a depth of 18 cm and made of a 50:50 mixture of gypsum and quartz powder, fired in a kiln at 720° C. for 20 min, maintained at 530° C. for 6 hours and then slowly cooled to room temperature over 15 hours, to obtain a glass article.

### EXAMPLE 8

### Preparation of a Glass Article by a Fusion Process and a Blowing Process Using Quartz Powder and Pigment

A glass article was prepared by a fusion process and a blowing process using two sheets of soda glass available from Hanglass, Korea. As a lower glass sheet, a 5 mm thick transparent soda glass having a size of 10 cm×10 cm was used, and as an upper glass layer, a 5 mm thick transparent soda glass having a size of 10 cm×10 cm was used. A pre-designed pattern was formed on the surface of the lower glass layer using an adhesive, and then the pattern was treated with a mixture of quartz powder, pigment and water at a volume ratio of 5:3:2. In the above patterning step, as the quartz powder, white quartz powder was used, and as the pigment, a low-fired pigment was used. Subsequently, the upper glass layer was laminated thereon to form a glass laminate. The glass laminate having the pattern embedded therebetween was de-watered at 40° C. for 1 hour. Subsequently, the dry glass laminate was disposed on a biscuit fired and dish-shaped porcelain mold, fired in a kiln at 750° C. for 1 hour, maintained at 530° C. for 7 hours and then slowly cooled to room temperature over 12 hours, to obtain a primary glass product. Then, the primary glass product was preheated in a pickup kiln at 600° C. for 2 hours. Subsequently, a wad of molten glass was formed on the end of an blowpipe using a glass rod (Kugler, Germany) and then transparent molten glass was gathered once more thereon. The preheated primary glass product was adhered thereto and then air blowing and thermal treatment were performed to obtain a product having a predetermined shape. Shortly after the blowing process, the blown product was placed in an annealing furnace so that it was maintained at 530° C. for 6 hours and then slowly cooled to room temperature over 15 hours, to obtain a glass article.

While the invention has been described with respect to the above specific embodiments, it should be recognized that various modifications and changes may be made to the invention by those skilled in the art which also fall within the scope of the invention as defined by the appended claims.

What is claimed is:

1. A glass article having a pattern embedded therein using at least one patterning material selected from the group consisting of a clay and a quartz powder.

2. The glass article of claim 1, wherein the patterning material further comprises a pigment.

3. A method of preparing a glass article having a pattern embedded therein, comprising:
disposing a first glass layer on a fire-resistant substrate;
forming a pattern on the surface of the first glass layer using at least one patterning material selected from the group consisting of a clay and a quartz powder;
disposing a second glass layer on the patterned surface of the first glass layer, to form a glass laminate;
drying the glass laminate at 30° C. to 50° C.;
firing the dried glass laminate at 700° C. to 800° C.; and
maintaining the fired glass laminate at 500° C. to 600° C. for 1 to 10 hours to anneal the fired laminate, followed by slowly cooling the annealed glass laminate to room temperature.

4. The method of claim 3, wherein the patterning material further comprises a pigment, an adhesive, water, or a combination thereof.

5. The method of claim 3 or 4, wherein at least one of the fire-resistant substrate, the first glass layer, and the second glass layer is furnished with at least one exhaust port.

6. The method of claim 3 or 4, wherein at least one of the first glass layer and the second glass layer is of a mosaic form composed of two or more glass pieces.

7. The method of claim 3 or 4, wherein the patterning material is a quartz powder, and the method further comprises a second firing step which is composed of disposing the glass laminate obtained after slowly cooling the annealed glass laminate obtained in the last step on a fire-resistant mold, firing the glass laminate at 700° C. to 800° C., maintaining the glass laminate at 500° C. to 600° C. for 1 to 10 hours, and slowly cooling the glass laminate to room temperature.

8. The method of claim 3 or 4, wherein the patterning material is a quartz powder, and the method further comprises the step of blowing the glass laminate obtained after slowly cooling the annealed glass laminate obtained in the last step.
